(19) United States
(12) Patent Application Publication
(10) Pub. No.: US 2026/0128795 A1
(43) Pub. Date: May 7, 2026

(54) OPTICAL INTERFACES AND POWER SOLUTIONS FOR CIRCUIT ASSEMBLIES

(71) Applicant: Infineon Technologies Austria AG, Villach (AT)

(72) Inventor: Muzammil A. ARAIN, Milpitas, CA (US)

(21) Appl. No.: 18/939,003

(22) Filed: Nov. 6, 2024

(51) Int. Cl. H04B 10/40; H04B 10/516; H04B 10/60

(52) U.S. Cl. CPC H04B 10/40; H04B 10/516; H04B 10/60

(57) ABSTRACT

An apparatus as discussed herein includes a stack of circuit layers. One layer in the stack includes a first circuit assembly. The first circuit assembly includes: a first surface and a second surface; a first interface of the first circuit assembly is operative to couple the first surface of the first circuit assembly to a first substrate disposed in a second layer of the stack. The first circuit assembly further includes a second interface operative to provide first connectivity from the first circuit assembly to an optical component assembly at a third layer in the stack. The first circuit assembly is disposed between the second layer and the third layer in the stack. The optical component assembly may include multiple optical devices controlled via driver circuitry disposed in the first circuit assembly. The multiple optical devices may support transmission and reception of optical signals.

### BACKGROUND

A printed circuit board (PCB) or printed wiring board is a laminated structure of conductive layers separated by insulating layers. In general, PCBs have two functions. The first is to secure electronic components at designated locations on the outer layers of the PCB by means of affixing such as soldering. The electronic circuit instantiated by the populated circuit board is designed to provide one or more specific functions. After fabrication, the electronic circuit is powered to perform the desired functions.

Typically, a printed circuit board is a planar device on which multiple components are interconnected via traces to provide the functions as previously discussed. Such implementations of fabricating circuitry such as a power converter, computer device, and an optical interface on a planar circuit board assembly is dimensionally limited.

One type of electronic components are integrated circuits (ICs). Some example of ICs are computer CPU, GPU, and data processing device. These IC include IC substrates which are essential for connecting ICs to the PCBs. These substrates provide connections between multiple chips and PCBs, protect and support the chips (ICs), protect and support ICs, and distribute power and input/output signals use to communicate with other ICs, PCBs, and systems. It is noted that the package substrate or IC substrate is sometimes termed as interposer especially when the substrate provides connections between different types of ICs, for example, electronic and optical ICs.

### BRIEF DESCRIPTION

Implementation of clean energy (or green technology) is very important to reduce our impact as humans on the environment. In general, clean energy includes any evolving methods and materials to reduce an overall toxicity of energy consumption on the environment.

This disclosure includes the observation that raw energy, such as received from green energy sources or non-green energy sources, typically needs to be converted into an appropriate form (such as desired AC voltage, DC voltage, etc.) before it can be used to power end devices such as servers, computers, mobile communication devices, etc. Regardless of whether energy is received from green energy sources or non-green energy sources, it is desirable to make most efficient use of raw energy provided by such systems to reduce our impact on the environment. This disclosure contributes to reducing our carbon footprint (and green energy) via more efficient energy conversion, optical signal conversion, and circuit implementations supporting same. In one example, optical signal conversion may be used for connecting different ICs (integrated circuits) located on different PCBs (printed circuit boards) together, which may be implemented in data centers.

One example as discussed herein includes use of vertical Optical I/O (Input/Output) circuitry to solve these challenges of connecting multiple computer systems together over larger distances.

More specifically, an apparatus as discussed herein includes a first circuit assembly. The apparatus can be configured to include a stack of layers (circuit component layers). In one example, a first layer in the stack includes a first circuit assembly. The first circuit assembly may include: a first surface and a second surface. A first interface of the first circuit assembly is operative to couple the first surface and corresponding interface of the first circuit assembly to a first substrate disposed in a second layer of the stack. The first circuit assembly further includes a second interface operative to provide first connectivity from the first circuit assembly to an optical component assembly at a third layer in the stack. The first circuit assembly may be disposed between the second layer and the third layer in the stack. The optical component assembly may include multiple optical devices (circuit components) controlled via driver circuitry disposed in the first circuit assembly. The multiple optical devices may support transmission and reception of optical signals.

In one example, the multiple optical devices of the optical component assembly may be configured to receive and transmit optical signals propagating substantially orthogonal with respect to the second surface of the first circuit assembly. The first circuit assembly may further include: a third interface disposed on the second surface, the third interface operative to provide second connectivity of the first circuit assembly to a load; and electrically conductive paths supporting third connectivity between the load and the driver circuitry disposed in the first circuit assembly.

Yet further, the optical component assembly as discussed herein can be configured to include a third substrate; where the multiple optical devices are disposed on a surface of the third substrate, the surface of the third substrate may be disposed parallel to the second surface of the first substrate.

In accordance with still further examples, the apparatus as discussed herein can be configured to include a processor component (a.k.a., load) coupled to the second surface of the first circuit assembly; the processor component may be disposed adjacent to the optical component assembly. One function of the optical component assembly may be to transmit data from the processor component included in the present assembly to other processors present in the system. Another function of the optical assembly may be to receive data from other processor component present in the system and send it to a processor component coupled to the second surface of the first circuit assembly. The apparatus may further include electrically conductive paths disposed in the first circuit assembly between the driver circuitry and the processor component.

In still further examples, the apparatus as discussed herein may include a redistribution layer disposed between the second surface of the first circuit assembly and the optical component assembly; the redistribution layer may include electrically conductive paths operative to convey signals between the multiple optical devices of the optical component assembly and a data processor affixed to the redistribution layer. The multiple optical devices may include optical transmitter devices and optical receiver devices; each respective optical transmitter device of the optical transmitter devices can be configured to convert a respective electrical signal received from the data processor into a respective optical signal transmitted from the respective optical transmitter device; and each respective optical receiver device of the optical receiver devices can be configured to convert a respective optical signal received by the respective optical receiver device into a respective electrical signal transmitted to the data processor. In this example, the first circuit assembly may provide the function of an interposer.

Still further, the first substrate as discussed herein may be a motherboard substrate operative to supply power to the first circuit assembly.

Another example of the apparatus as discussed herein includes: i) an electronic component coupled to the second surface of the first circuit assembly, the electronic component being disposed adjacent to the optical component assembly; ii) first electrically conductive paths extending through the first circuit assembly between the electronic component and optical transmitter devices disposed in the optical component assembly, the first electrically conductive paths operative to convey first electrical signals from the electronic component to the optical transmitter devices; and iii) second electrically conductive paths extending through the first circuit assembly between optical receiver devices of the optical component assembly and the electronic component, the second electrically conductive paths operative to convey second electrical signals from the optical receiver devices to the electronic component.

In a further example, the multiple optical devices of the optical component assembly are coupled to a surface of the optical component assembly, where the multiple optical devices configured to receive/transmit optical signals which travel in a direction substantially orthogonal with respect to the surface of the optical component assembly before they are routed to an optical fiber.

Still further, the optical component assembly as discussed herein may include: i) a third substrate coupled to the second interface of the first circuit assembly, and ii) where the multiple optical devices are affixed to a first surface of the third substrate, the first surface of the third substrate disposed parallel to the second surface of the first circuit assembly.

Yet further examples as discussed herein include a component stack comprising: a first layer including the optical component assembly as previously discussed; a second layer including the first circuit assembly as previously discussed. The first circuit assembly can be configured to include: i) a power converter disposed between the first surface of the first circuit assembly and the second surface of the first circuit assembly, the power converter operative to convert a received input voltage into an output voltage, and ii) electrically conductive paths operative to convey the output voltage from the power converter to the multiple optical devices of the optical component assembly; iii) a third layer including the first substrate; and wherein the second layer is disposed between the first layer and the second layer.

Yet another example as discussed herein includes an implementation in which the second interface includes a third substrate disposed between the first circuit assembly and the optical component assembly, where the third substrate provides electrical connectivity between the first circuit assembly and the optical component assembly.

Further examples as discussed herein include an apparatus comprising: a substrate; a modulator assembly; and an optical transmitter device affixed to the substrate, the optical transmitter device configured to transmit an optical signal transmitted in a direction orthogonal to the surface of the substrate, the optical signal including different wavelengths transmitted to optical modulator elements in the modulator assembly, each of the optical modulator elements operative to control modulation of a respective received wavelength of the different wavelengths of the optical signal onto an optical fiber for transmission over the optical fiber to a remote destination. In one example, the controlled modulation as discussed herein corresponds to the data that needs to be sent from the processor unit attached to the first circuit assembly to other processor units in the system. It is also noted that the data can be broken into multiple parallel paths to increase the bandwidth capacity of the data transmission system where each modulator assembly transmits part of the data that needs to be transmitted.

The apparatus may include an optical lens disposed between the optical transmitter device and the optical modulator elements in the modulator assembly.

Still further, the apparatus may include electrically conductive paths extending through the substrate to the optical modulator elements in the modulator assembly, the electrically conductive paths operative to convey modulator control signals to the optical modulator elements of the modulator assembly. The modulator control signals may include a first modulator control signal conveyed from the substrate to a first optical modulator element of the modulator assembly, the first optical modulator element operative to modulate a first wavelength of the multiple different wavelengths in accordance with the first modulator control signal; and the modulator control signals may include a second modulator control signal conveyed from the substrate to a second optical modulator element of the modulator assembly, the second optical modulator element can be configured to modulate a second wavelength of the multiple different wavelengths in accordance with the second modulator control signal.

Another apparatus as discussed herein includes: a substrate; an optical interface to receive an optical signal; an optical splitter disposed between the optical interface and the substrate, the optical splitter operative to split the received optical signal into different wavelengths; and multiple optical receiver devices affixed to a surface (such as a planar surface or nonplanar surface) of the substrate, the multiple optical receiver devices operative to receive the different wavelengths of the optical signal, the different wavelengths of the optical signal received by the multiple optical receiver devices in a direction orthogonal to the surface of the substrate.

The optical splitter may include a wavelength demultiplexer operative to split the received optical signal into the different wavelengths of the optical signal.

The multiple optical receiver devices include a first optical receiver device affixed to the substrate, the first optical receiver device operative to receive a first wavelength of the optical signal and convert the received first wavelength of the optical signal into a first electrical signal; where the multiple optical receiver devices include a second optical receiver device affixed to the substrate, the second optical receiver device operative to receive a second wavelength of the optical signal and convert the received second wavelength of the optical signal into a second electrical signal. The apparatus may further include: a first electrically conductive path extending from the first optical receiver device through the substrate, the first electrically conductive path operative to convey the first electrical signal; and a second electrically conductive path extending from the second optical receiver device through the substrate, the first electrically conductive path operative to convey the first electrical signal. The multiple receivers can be configured to receive the data from other processor units in the system from where data needs to be shared with the processor unit or units attached to the first circuit assembly in a parallel manner to increase the capacity of the data transmission.

Note that for both data transmission and reception, it is not uncommon to convert the speed of the data from one value to another. So-called retimer circuits are well known in transmission devices and are usually included in the driver assembly to change data speed as well as number of channels.

Note that this disclosure includes useful techniques. For example, in contrast to conventional techniques, the circuits as discussed herein include a novel stacking of circuitry to form an assembly. This disclosure further includes a novel implementation of optical transmitter circuitry and a novel implementation of optical receiver circuitry.

Note further that any of the resources as discussed herein can include one or more computerized devices, apparatus, hardware, etc., execute and/or support any or all of the method operations disclosed herein. In other words, one or more computerized devices or processors can be programmed and/or configured to operate as explained herein to carry out the different techniques as described herein.

Other aspects of the present disclosure include software programs and/or respective hardware to perform any of the operations summarized above and disclosed in detail below.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of techniques herein (BRIEF DESCRIPTION) purposefully does not specify every novel aspect of the present disclosure or claimed invention(s). Instead, this brief description only presents general aspects and corresponding points of novelty over conventional techniques. For additional details and/or possible perspectives (permutations) of the invention(s), the reader is directed to the Detailed Description section (which is a summary) and corresponding figures of the present disclosure as further discussed below.

### BRIEF DESCRIPTION OF THE DRAWINGS

FIG. 1 is an example illustrating fabrication and implementation of an apparatus including a circuit assembly disposed in a stack of circuit layers as discussed herein.

FIG. 2A is an example side view diagram of an optical component assembly as discussed herein.

FIG. 2B is an example top view diagram of the optical component assembly as discussed herein.

FIG. 3 is an example diagram illustrating fabrication of an apparatus including one or more silicon photonics chips to support optical communications as discussed herein.

FIG. 4 is an example side view diagram illustrating implementation of an optical communication system including an optical component assembly to transmit data in one or more optical signals as discussed herein.

FIG. 5 is an example side view diagram illustrating implementation of an optical system including an optical component assembly to receive and process one or more received optical signals as discussed herein.

FIG. 6 is an example diagram illustrating fabrication of an apparatus including a stack of multiple circuit layers supporting transmission and reception of data the optical signals as discussed herein.

FIG. 7 is an example illustrating fabrication and implementation of an apparatus including a circuit assembly disposed in a stack of circuit layers as discussed herein.

The foregoing and other objects, features, and advantages of the disclosed matter herein will be apparent from the following more particular description herein, as illustrated in the accompanying drawings in which like reference characters refer to the same parts throughout the different views. The drawings are not necessarily to scale, with emphasis instead being placed upon illustrating the principles, concepts, aspects, techniques, etc.

### DETAILED DESCRIPTION

As previously discussed, this disclosure is useful over conventional techniques. For example, in contrast to conventional techniques, the novel assemblies as discussed herein include fabrication of stacked circuitry and corresponding circuit component layers to support more efficient powering of optical devices and transmission and reception of optical signals. Further, note that the stacking of circuitry may include a novel component layer including an optical component assembly supporting efficient transmission and reception of optical signals.

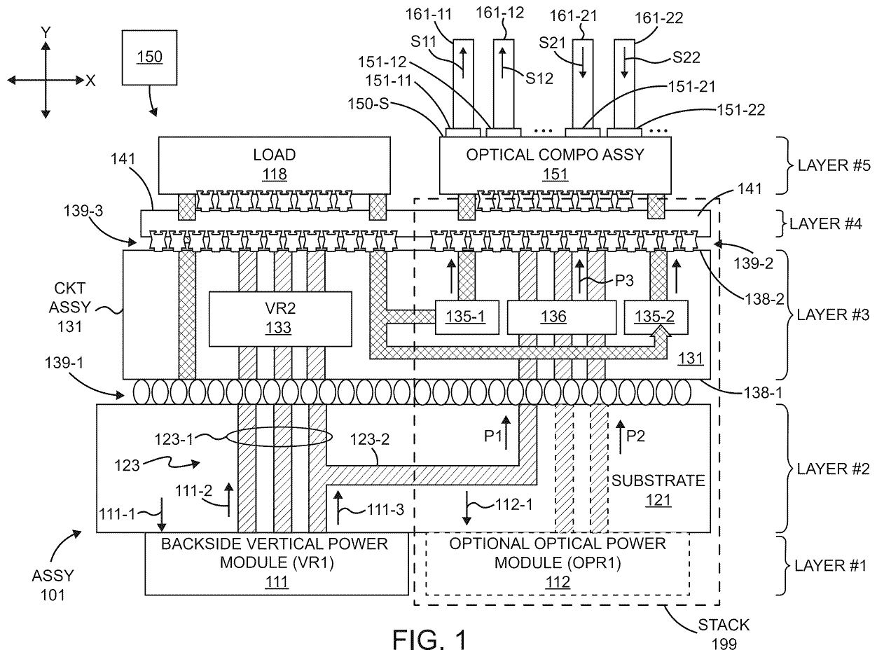

Now, more specifically, FIG. 1 is an example illustrating fabrication of an apparatus including a circuit assembly disposed in a stack of circuit layers as discussed herein.

As shown in FIG. 1, a fabricator 150 or other suitable entity fabricates the assembly 101 to include multiple layers of circuitry such as one or more of layer #1, layer #2, layer #3, layer #4, and layer #5.

In this example, the layer #1 includes one or more power converters (a.k.a., voltage regulators) to convert a received one or more input voltages into a respective one or more output voltages. For example, the power converter 111 in the layer #1 can be configured to receive a respective one or more input voltages 111-1 from the substrate 121 in layer #2 or other suitable entity. The power converter 112 in the layer #2 can be configured to receive a respective one or more input voltages 112-1 from the substrate 121 in the layer #2 or other suitable entity.

As further shown, the layer #2 may include a substrate 121. In this example, the substrate 121 includes corresponding electrically conductive paths 123 providing connectivity of the power converter 111 to the interface 139-1 (including one or more electrically conductive paths, solder joints, etc.) electrically connecting the substrate 121 to the circuit assembly 131. For example, the electrically conductive paths 123-1 convey the one or more output voltages 111-2 produced by the power converter 111 through the substrate 121 to the circuit assembly 131 in the layer #3.

Additionally, the substrate 121 can be configured to include the one or more electrically conductive paths 123-2 to convey the one or more output voltages from the power converter 111 to the circuit assembly 131 and corresponding components therein.

In one example, the substrate 121 in layer #2 of the assembly 101 is a so-called motherboard substrate or other suitable entity supplying power P1, P2, etc., (voltages or currents) to the first circuit assembly 131.

The layer #3 may include the circuit assembly 131. In one example, the circuit assembly 131 of the assembly 101 includes a first surface 138-1 and a second surface 138-2. The assembly 101 and corresponding circuit assembly 131 further include a respective first interface 139-1 operative to couple the first surface 138-1 of the first circuit assembly 131 to the substrate 121 in layer #2.

Additionally, the assembly 101 and corresponding circuit assembly 131 can be configured to include a second interface 139-2 (such as including electrically conductive path, solder balls, solder joints, etc.) operative to provide connectivity from the first circuit assembly 131 to an optical component assembly 151 in layer #5. As shown, the assembly 101 may optionally include the layer #4 and corresponding redistribution layer 141.

As discussed herein, the optical complement assembly 151 can be configured to include one or more optical devices (151-11, 151-12, . . . , 151-21, 151-22, . . . ) controlled via driver circuitry 135 (135-1, 135-2, etc.) disposed in the first circuit assembly 131 between the first surface 138-1 and the second surface 138-2 in layer #3 of the stack 199.

The layer #5 in the stack of layers associated with the assembly 101 includes one or more of a load 118 (such as a data processing unit) and an optical component assembly 123.

On the left side of FIG. 1, the load 118 in the layer #5 may be a data processor (such as including an ASIC, CPU, GPU, etc.) affixed to the redistribution layer 141 (itself a single or multilayer substrate) and layer #4.

The layer #4 may include a redistribution layer 141 and/or an interposer. The interposer layer is an optional layer which could be like layer #3 in structure. It can be part of layer #4. The redistribution layers (RDLs) and interposers in layer #4 are used to redistribute electrical connections and improve routing. The interposer and layer #4 can be configured to include electrical interfaces that route connections between sockets or other connections. They can be used to spread a connection to a wider pitch or to reroute a connection to a different connection.

As further shown, the layer #3 may include a so-called package substrate such as including circuit assembly 131. Any of the substrates or packages as discussed herein can be configured to include active or passive circuit components in them. It is also noted that in some cases, layer #3 also acts as an interposer. In such cases, layer #3 may be duplicated as needed.

In one example, the stack of components such as combination of the circuitry at layer #5, layer #4, layer #3, may be connected to the substrate 121 such as a so-called motherboard through interface 139-1 such as including solder bumps or micro-bumps depending upon the density of the connections. Some of the solder bumps in the interface 139-1 can be used for conveying power while others can be used for I/O connections between the layer #2 in the layer #3. The I/O (Input Output) connections can then be routed to the motherboard.

As further shown, the assembly 101 supports a method of powering and connecting to the load 118 through I/O pins as shown. For example, layer #1 can be configured to include a so-called vertical power module (power converter 111) that can be configured to supply a voltage level V1 (e.g., 6-8 V) or other suitable voltage level through the substrate 121 to the circuit assembly 131 and corresponding power converter 133. This allows lower currents to be passed to the package substrate (a.k.a, circuit assembly 131).

Next, the power converter 133 such as a voltage level converter VR2 can be embedded in the substrate (circuit assembly 131) itself. The power converter 133 can be configured to convert the voltage levels from say 6-8 VDC (such as received from the power converter 111 or other suitable entity) to 1 VDC typically supplied to and used by the load 118 as well as provide any voltage regulation needed to control the power supply to the load 118 as the load 118 consumes a variable amount of current corresponding power. Accordingly, the power provided by the power converter 133 through the redistribution layer 141 to the load 118 is needed by the load 118.

As further shown in FIG. 1, the assembly 101 includes the optical component assembly 151. The optical component assembly 151 is disposed in the layer #5 and either directly connects to the circuit assembly 131 or is connected to the circuit assembly 131 via or through the redistribution layer 141 in layer #4.

It is noted that the power generated by the power converter 111 in the assembly 101 can also be shared. For example, the power converter 111 can be configured to provide power (111-2) to the power converter 133 or load 118 as well as to the circuit components in the layer #3. It is noted that a significant amount of power may be needed to support conveyance of data between the load 118 and the optical component assembly 101 as well as transmission and reception of optical signals with respect to the optical component assembly 151 via the optical devices 151-11, 151-12, . . . , 151-21, 151-22, . . . It is desirable that the optical component assembly 151 and corresponding circuitry (such as optical devices) disposed in the circuit assembly 131 supporting communications with the load 118 support conveyance of large amounts of data.

In this example, note that the power converter 112 such as OPR1 and the power converter 136 such as OPR2 can be configured to support generation of different output voltages similar to power converter 111 and power converter 133. In one example, the output voltage generated by the power converter 112 is at a higher voltage than an output voltage produced by the power converter 136. Note further that the power converter 136 may also provide more than one voltage levels needed for the operation of the optical component assembly 151 (a.k.a., Optical I/O module). In other words, the optical devices 151-11, 151-12, . . . , 151-21, 151-22, . . . , may require different voltages for powering and/or other purposes.

Here, the power converter 136 and corresponding driver circuitry 135-1 and driver circuitry 135-2 are disposed in the layer #3 and corresponding circuit assembly 131. In this example, the driver circuitry 135-1 can be configured as a driver associated with the transmitter part of the optical component assembly 151 (a.k.a., optical I/O module) while the driver circuitry 135-2 can be configured as a driver associated with the receiver optical module.

Each set of driver circuitry 135 may include active circuit components as well as passive circuit components. For example, the receiver driver module (135-2) can be configured to receive electrical signals encoded with data from optical receiver devices 151-21, 151-22, etc., and convert received signals from current to voltage as well as deserialize such data to change it from x number of channels to y number of channels if desired. The receiver driver module (135-2) can also be configured to change the speed of the data transfer from one speed to another. In a general case, the receiver driver module can change both the number of channels as well as the frequency of operation of data transfer. The driver circuitry 135-1 can be configured as a driver that drives the optical light sources or the modulators associated with the optical transmitter devices 151-11, 151-12, etc., which is needed to convert the I/O data from the electrical domain to optical domain.

Additional details of the novel stacking of components 199 and corresponding optical component assembly 151 are further discussed below.

Thus, the proposed system and corresponding assembly 101 (including stacking of components 199) provides an efficient way of transmitting the data from load 118 to the other modules in the system via the optical component assembly 151. This arrangement of layers and stacking of components 199 in the assembly 101 lowers the complexity of the system by allowing use of less area around the load 118.

It is further noted that the stacking and placement of components in the assembly 101 as shown in FIG. 1 supports cooling to be applied on the top side of the assembly 101 without restriction.

Thus, as further shown, on the right-hand side of FIG. 1, the assembly 101 may include the optical component assembly 151. The optical component assembly 151 may include multiple optical transmitter/receiver devices such as optical device 151-11, optical device 151-12, . . . , optical device 152-21, optical device 152-22, etc.

Note that each of the optical devices in the optical component assembly 151 may be an optical transmitter or an optical receiver.

For example, the optical device 151-11 may be an optical transmitter (including any circuitry, one or more optical components, etc.) operative to receive control and other input from the driver circuitry 135-1 in the layer #3 or other suitable entities. The driver circuitry 135-1 controls operation of the optical device 151-11 to transmit first data (such as first serial data bits conveyed via a first electrical signal) received from the load 118 over a respective circuit path (a.k.a., electrically conductive path) extending from the load 118 or other suitable entity, through the redistribution layer 141 if present, through the circuit assembly 131 to the transmitter driver circuitry 135-1. Based on the received first serial data bits in the electrical signal received from the load 118 or other suitable entity, the transmitter driver circuitry 135-1 controls transmission of one or more control and other signals through the circuit assembly 131-1 (layer 3) and through the redistribution substrate 141 (if present) to the optical device 151-11 of the optical component assembly 151. Based on control input received from the driver circuitry 135-1 and/or the redistribution layer 141, the optical device 151-11 converts the electrical signal including the first data (such as first serial data bits) from the load 118 into an optical signal S11 transmitted from the optical device 151-11 over the respective optical fiber 161-11. As further discussed herein, the optical transmitter device 151-11 can be configured to transmit the first serial data bits in the optical signal S11 at any suitable one or more wavelengths through one or multiple fibers including multi-core fibers.

In a similar manner, the optical device 151-12 may be an optical transmitter (including any circuitry or optical components) operative to receive control and/or other input from the driver circuitry 135-1 in the layer #3. The driver circuitry 135-1 controls operation of the optical device 151-12 to transmit second data (such as second serial data bits conveyed via a second electrical signal) received from the load 118 over a respective circuit path (electrically conductive path) extending from the load 118, through the redistribution layer 141, through the circuit assembly 131 to the transmitted driver circuitry 135-1. Based on the received second serial data bits in the electrical signal from the load 118 or other suitable entity, the driver circuitry 135-1 transmits the corresponding one or more control signals through the circuit assembly 131-1 (layer 3) and through the redistribution substrate 141 to the optical device 151-12 of the optical component assembly 151. Based on control input received from the driver circuitry 135-1, the optical device 151-12 converts the electrical signal including the second data (such as second serial data bits) as optical signal S12 transmitted over the respective optical fiber 161-12. As further discussed herein, the optical transmitter device 151-12 can be configured to transmit the second serial data bits in the optical signal S12 at any suitable one or more wavelengths using one or multiple fibers including one or more multi-core fibers.

In a similar manner, the driver circuitry 135-1 can be configured to drive any number of transmitter optical devices in the optical component assembly 151. As previously discussed, the multiple optical devices such as optical device 151-11, 151-12, etc., of the optical component assembly 151 can be configured to transmit optical signals S11, S12, etc., which are initially transmitted from a respective optical device in parallel with the y-axis. In other words, the y-axis in this example is substantially orthogonal to the surface 138-2 (such as x-z plane) of the circuit assembly 131. Thus, the optical signals S11, S12, etc., may be transmitted along the y-axis substantially orthogonal with respect to the (planar) surface 138-2 of the circuit assembly 131 or substantially orthogonal with respect to a top surface 150-S (such as planar surface disposed in the x-z plane) of the optical component assembly 151.

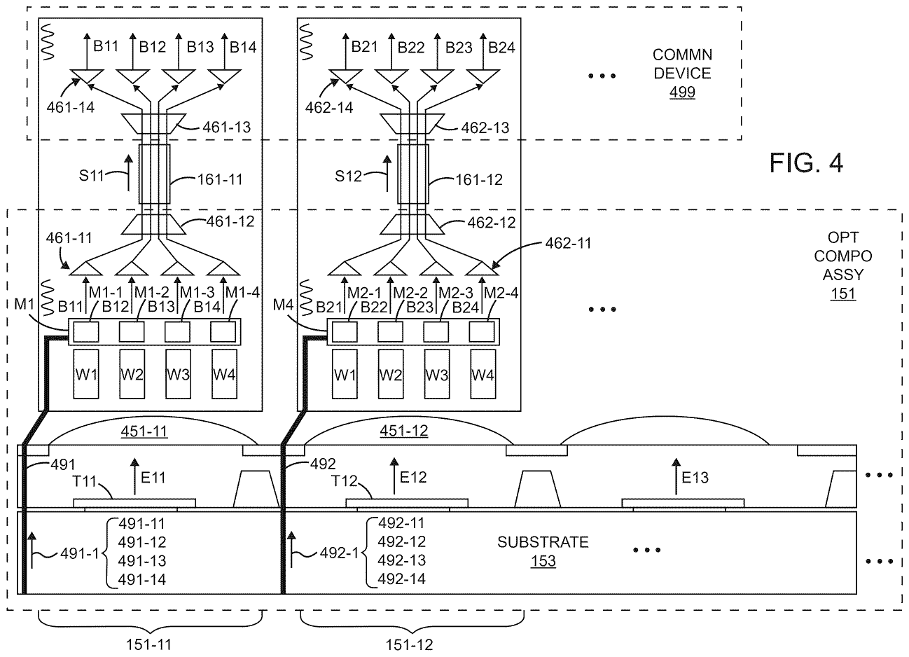

Additional details of the optical component assembly 151 and corresponding optical transmitter devices such as optical device 151-11, optical device 151-12, etc., is shown and discussed in FIG. 4.

Referring again to FIG. 1, it is further noted that the optical device 151-21 may be an optical receiver (including any circuitry or optical components) operative to convert a received optical signal S21 into one or more electronic signals based on control input from the driver circuitry 135-1 in the layer #3. More specifically, the driver circuitry 135-2 can be configured to control reception and conversion of the optical signal S21 conveyed over the optical fiber 161-21 to the optical device 151-21.

Note that the optical signal S21 may include one or more wavelengths of light, each carrying a potentially different data stream of data bits. The optical device 151-21 can be configured to convert the received one or more optical signal S21 into corresponding one or more electrical signals transmitted from the optical device 151-21 through the optical component assembly 151, through the redistribution layer 141, to the circuit assembly 131. The circuit assembly 131 further can be configured to include one or more electrically conductive path operative to further convey the electrical signals through the circuit assembly 131 to the interface 139-3, which conveys the electrical signals via corresponding electrically conductive paths upward to the load 118. The conveyed electrical signals include the corresponding data obtained from the optical signal S21.

The optical device 151-22 may be an optical receiver (including any circuitry or optical components) operative to convert a received optical signal into one or more electrical signals based on control and/or other input from the driver circuitry 135-1 in the layer #3. More specifically, the driver circuitry 135-2 can be configured to control reception and conversion of the optical signal S22 conveyed over the optical fiber 161-22 to the optical device 151-22. The optical signal S22 may include one or more wavelengths of light, each carrying a potentially different data stream. The optical device 151-22 can be configured to convert the received optical signal S22 into corresponding one or more electrical signals transmitted from the optical device 151-22 through the optical component assembly 151, through the redistribution layer 141, to the circuit assembly 131. The circuit assembly 131 further can be configured to include one or more electrically conductive paths and/or drivers operative to further convey the electrical signals through the circuit assembly 131 to the interface 139-3, which conveys the electrical signals upward to the load 118. Thus, the conveyed electrical signals include the corresponding data obtained from the optical signal S22.

In a similar manner, the driver circuitry 135-2 can be configured to drive/power/control any number of optical receiver devices in the optical component assembly 151. As previously discussed, the multiple optical receiver devices such as optical device 151-21, 151-22, etc., of the optical component assembly 152 can be configured to receive optical signals S21, S22, etc., which are received directionally and substantially in parallel with the y-axis. In other words, the y-axis in this example may be substantially orthogonal to the surface 138-2 of the circuit assembly 131. Thus, the optical signals S21, S22, etc., may be transmitted parallel to the y-axis and thus received substantially orthogonal to the surface 138-2 of the circuit assembly 131 or substantially orthogonal to a top surface 150-S of the optical component assembly 151 disposed in the x-z plane.

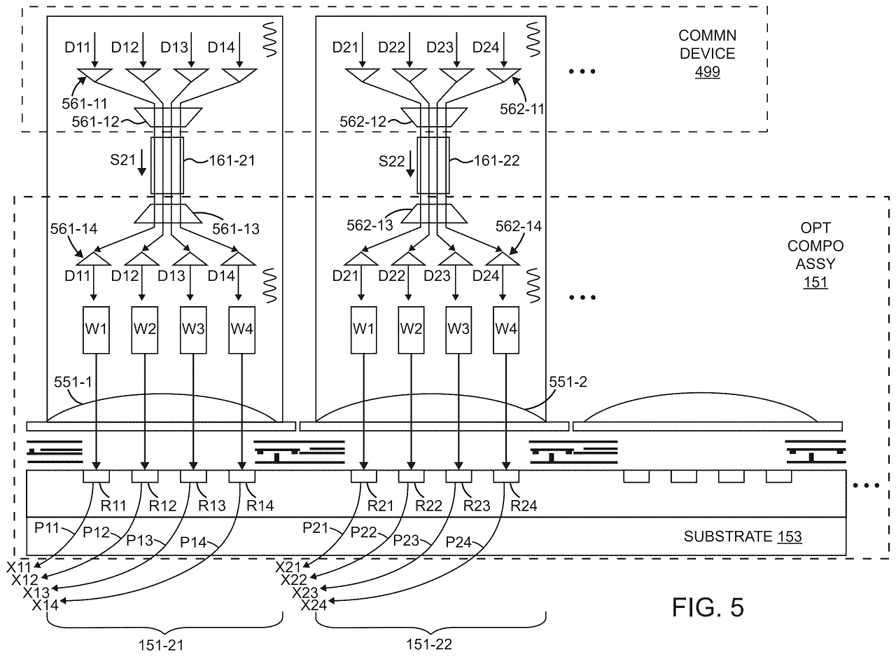

Additional details of the optical component assembly 151 and corresponding optical receiver devices such as optical device 151-21, 151-22, etc., is shown in FIG. 5.

Referring again to FIG. 1, the following observations are provided with respect to the assembly 101. For example, it is noted from the above discussion that examples as discussed herein include the circuit assembly 131 including a third interface 139-3 disposed on the surface 138-2. The third interface 139-3 can be configured to provide connectivity of the first circuit assembly 131 through the redistribution layer 141 to the load 118. This connectivity supports operations such as conveyance of data as received from the signal S21, S22, etc., or transmitting data eventually encoded in the signal S11, S12, etc. The assembly 101 can be configured to include any number of electrically conductive paths supporting connectivity between the load 118 and the driver circuitry 135 (driver circuitry 135-1 and driver circuitry 135-2).

In a further example, the optical component assembly 151 may include a respective substrate. The multiple optical devices (such as optical device 151-11, optical device 151-12, . . . , 151-21, 151-22, . . . ) may be disposed on a top surface 150-S of the substrate in the optical component assembly 151. As previously discussed, the respective top surface (such as planar surface) of the substrate in the optical component assembly 151 may be disposed parallel to the second surface 138-2 of the circuit assembly 131. Planar surfaces of each of the optical devices optical device 151-11, optical device 151-12, . . . , 151-21, 151-22, . . . , in the x-z plane may be affixed to the surface of the optical component assembly 151. Such a configuration supports transmission of the optical signals S11, S12, etc., from the optical devices along the y-axis. This further supports reception of the optical signals S21, S22, etc., at the optical devices along the y-axis.

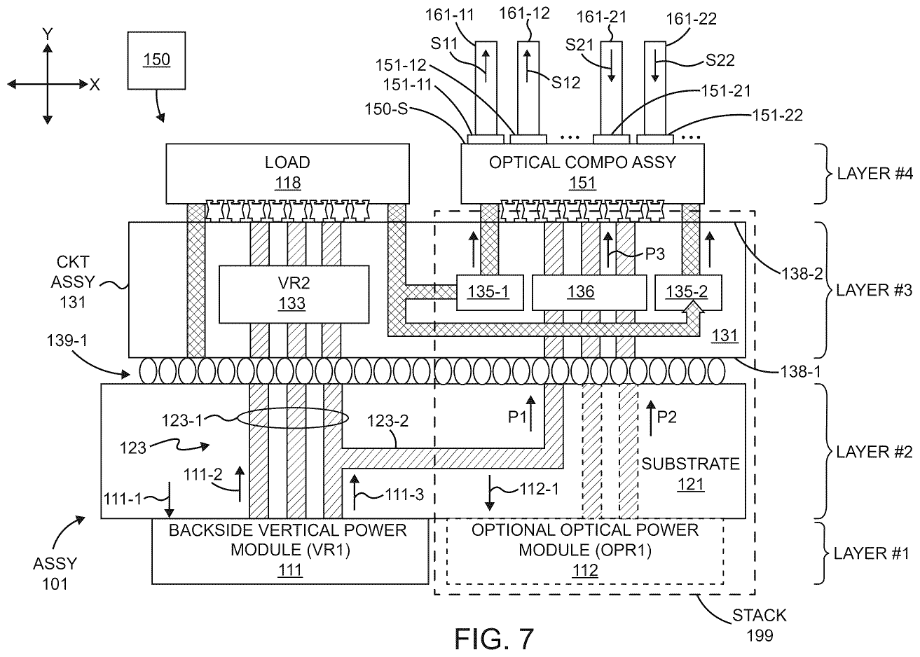

Further, as previously discussed, a load 118 such as a data processor component may be coupled directly or indirectly to the second surface 138-2 of the circuit assembly 131. Note that the load 118 can be directly connected to the surface 138-2 of the circuit assembly 131 during a condition in which the redistribution layer 141 is not present in the assembly 101 (see FIG. 7). Referring again to FIG. 1, alternatively, when the redistribution layer 141 is disposed in the assembly 101, the redistribution layer 141 provides connectivity between the bottom surface of the load 118 and the surface 138-2 of the circuit assembly 131.

Yet further, it is noted that the load 118 such as a processor component or other suitable data processing entity is disposed adjacent to the optical component assembly 151. As previously discussed, the redistribution layer 141 and/or the circuit assembly 131 include one or more electrically conductive paths to provide physical connectivity between the driver circuitry 135 and the load 118.

As previously discussed, an electronic component such as a load 118 may be coupled directly or indirectly to the surface 138-2 of the circuit assembly 131. The electronic component is disposed adjacent to the optical component assembly 151. The assembly 101 can be configured to include first electrically conductive paths extending through the first circuit assembly 131 between the electronic component (such as load 118) and optical transmitter devices 151-11, 151-12, etc., of the optical component assembly 151. Note further that the first electrically conductive paths can be configured to convey first electrical signals from the electronic component such as the load 118 or other suitable entity through the assembly 101 to the optical transmitter devices 151-11, 151-12, etc.

Additionally, the assembly 101 and the stack 199 can be configured to include second electrically conductive paths extending through the first circuit assembly 131 between optical receiver devices 151-21, 151-22, etc., of the optical component assembly 151 and the electronic component such as load 118. The second electrically conductive paths convey second electrical signals from the optical receiver devices 151-21, 151-22, etc., through the layer #3 including the circuit assembly 131 and/or layer #4 including the redistribution layer 141 of the assembly 101 to the load 118.

Yet further, as previously discussed, the multiple optical devices of the optical component assembly 151 may be coupled to a surface of the optical component assembly 151. The multiple optical devices can be configured to receive/transmit optical signals which travel in a direction substantially orthogonal (in the Y direction) with respect to the surface of the optical component assembly 151.

In further examples, the optical component assembly 151 can be configured to include: i) a substrate coupled to the second interface 139-3 of the circuit assembly 131; the multiple optical devices 151-11, 151-12, ..., 151-21, 151-22, etc., may be directly or indirectly affixed to a first surface of the substrate associated with the optical component assembly 101. Note further that the top planar surface and bottom planar surface of the optical component assembly 151 may be disposed in parallel to the second surface 138-2 of the circuit assembly 131.

Accordingly, the component stack of assembly 101 can be configured to include layer #3 including the circuit assembly 131. As further shown, the layer #3 such as including the circuit assembly 131 can be configured to include: i) a power converter 136 (a.k.a., power module) disposed between the first surface 138-1 of the circuit assembly 131 and the second surface 138-2 of the circuit assembly 131, where the power converter 133 is operative to convert a received input voltage into an output voltage, and ii) electrically conductive paths in the layer #3 that convey the output voltage P3 from the power converter 133 (a.k.a. voltage regulator) to the multiple optical devices (such as optical devices 151, optical devices 152, etc.) of the optical component assembly 151. In this manner, the circuit assembly 131 functions like an interposer connecting different types of devices together in a single substrate.

In a further example, the interface 139-2 can be configured to include a respective substrate such as the redistribution layer 141. As previously discussed, the redistribution layer 141 may be disposed between the circuit assembly 131 and the optical component assembly 151. The redistribution layer 141 can be configured to provide electrical connectivity between the first circuit assembly 131 and the optical component assembly 151 in the stack 199.

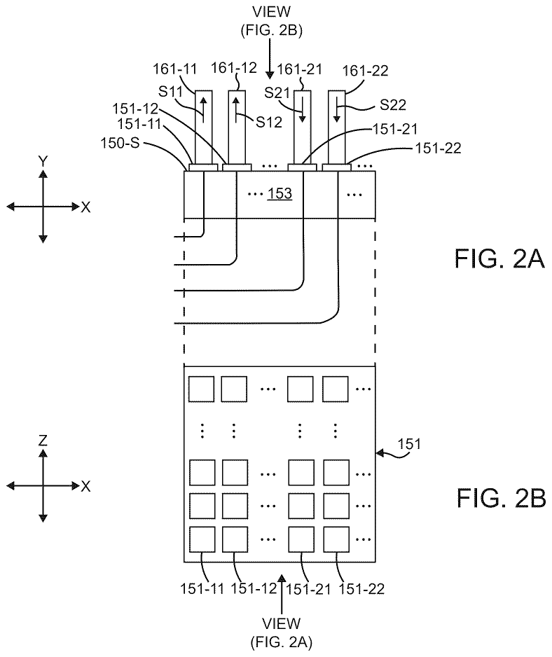

FIG. 2A is an example side view diagram of an optical component assembly as discussed herein.

As previously discussed, the optical component assembly 151 can be configured to include multiple optical devices (such as an array, two-dimensional array, etc.) including optical transmitter device 151-11, optical transmitter device 151-12, etc.

Additionally, the optical component assembly 151 can be configured to include optical receiver device 151-21, optical receiver device 151-22, etc.

In one example, the optical component assembly 151 includes substrate 153 such as fabricated from silicon or other suitable material. The multiple optical devices 151 (such as optical transmitter device 151-11, optical transmitter device 151-12, etc., as well as optical receiver device 151-21, optical receiver device 151-22, etc.) may be disposed on the substrate 153.

FIG. 2B is an example top view diagram of the optical component assembly as discussed herein.

In this example view, the optical component assembly 151 is viewed along the y-axis. The optical component assembly 151 as shown in FIG. 2B can be configured to include the multidimensional array (such as two-dimensional array) of optical devices such as including optical transmitter device 151-11, optical transmitter device 151-12, etc., as well as optical receiver device 151-21, optical receiver device 151-22, etc.

Each of the optical transmitter device in the optical receiver device may be a planar device (in the x-z plane). Accordingly, each of the optical transmitter device 151-11, optical transmitter device 151-12, etc., as well as optical receiver device 151-21, optical receiver device 151-22, etc., may be disposed in parallel with the top surface 150-S of the substrate 153.

As previously discussed, a corresponding optical fiber may be optically coupled to each of the optical devices. See a further example of the optical transmitter devices in FIG. 4. See a further example of the optical receiver devices in FIG. 5.

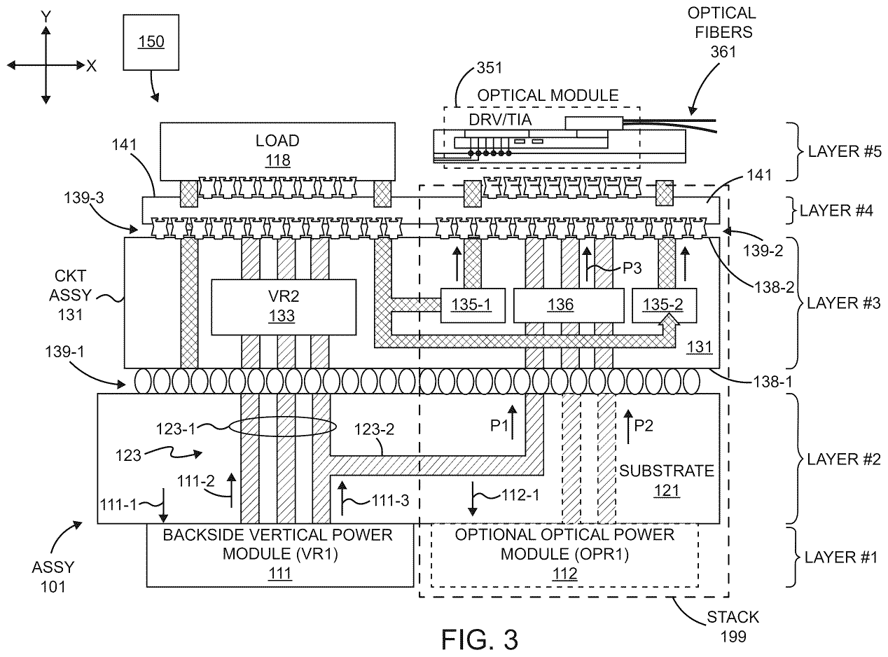

FIG. 3 is an example diagram illustrating fabrication of an apparatus including one or more silicon photonics chips to support optical communications as discussed herein.

In this example, the vertical stack of components 199 includes replacement of the optical component assembly 151 with the optical component assembly 351. In this example, the power converter 112 or the power converter 136 can be configured to supply power to the corresponding driver circuitry 135-1 and 135-2.

Further in this example, terminal ends of the optical fibers 361 extend to the optical component assembly 351, where optical signals in the fibers 361 are conveyed in parallel with the optical fibers 361 along the x-axis or parallel to the x-z plane.

FIG. 4 is an example side view diagram illustrating implementation of an optical communication system including an optical complement assembly to transmit data as discussed herein.

In this example, the optical component assembly 151 includes substrate 153. The substrate 153 can be fabricated from any suitable material to include the transmitter T11, transmitter T12, etc. The transmitters T11, T12, etc., may be light emitting diodes (a.k.a., LEDs), laser devices, etc., or other suitable entity capable of transmitting (emitting) a respective optical signal.

In a further example, the optical transmitter device 151-11 and corresponding optical transmitter T11 is affixed to or coupled to the substrate 153. The optical transmitter T11 can be configured to receive power from the driver circuitry 135-1 or other suitable entity. The received power is used to produce the transmitted optical signal E11. Further, in accordance with control input from the load 118, the driver circuitry 135-1 or other suitable entity transmits respective modulator control signals 491-1 over the electrically conductive path 491 to the optical modulator assembly M1.

As further shown, the optical modulator assembly M1 can be configured to include individual modulator (optical filters or other suitable entities) such as optical modulator M1-1, optical modulator M1-2, optical modulator M1-3, and optical modulator M1-4. The modulator assembly M1 can be configured to include any number of optical modulators such as one for each wavelength.

Yet further, the control signals 491-1 can be configured to include a first control signal 491-11 to control the optical modulator M1-1, a second control signal 491-12 to control the optical modulator M1-2, a third control signal 491-13 to control the optical modulator M1-3, a fourth control signal 491-14 to control the optical modulator M1-4.

As shown, the transmitter T11 of the optical transmitter device 151-11 emits the optical signal E11 (broadband light) such as including multiple wavelengths of light such as W1, W2, W3, and W4. In one example, the optical transmitter device 151-11 further includes the lens 451-11 (optional). The lens 451-11 is configured to appropriately direct the signal E 11 to the modulator assembly M1 and corresponding modulators. In one example, the transmitted signal E11 is a broadband signal that is not modulated but instead continuous transmitted light.

For example, the lens 451-11 receives the optical signal E11 (transmitted from the transmitter T11) and outputs the wavelength of light W1 associated with the optical signal E11 to the optical modulator M1-1; the lens 451-11 receives the optical signal E11 (transmitted from the transmitter T11) and outputs the wavelength of light W2 associated with the optical signal E11 to the optical modulator M1-2; the lens 451-11 receives the optical signal E11 (transmitted from the transmitter T11) and outputs the wavelength of light W3 associated with the optical signal E11 to the optical modulator M1-3; the lens 451-11 receives the optical signal E11 (transmitted from the transmitter T11) and outputs the wavelength of light W4 associated with the optical signal E11 to the optical modulator M1-4.

Yet further, as previously discussed, the electrically conductive path 491 conveys one or more control signals 491-1 from the driver circuitry 135-1 in the circuit assembly 131 (or driver circuitry at the load 118) to the optical modulator assembly M1.

Via the control signals 491-1, the driver circuitry 135-1 controls passage of the different wavelengths associated with the optical signal E11 to the WDM transmitters 461-11. For example, the control signal 491-11 controls modulator M1-1; the control signal 491-12 controls modulator M1-2; and so on.

The WDM transmitters 461-11 output the respective modulated wavelengths W1, W2, W3, W4 as produced by the optical modulator assembly M1 to the WDM transmitters 461-11. Each of the modulators in the modulator assembly M1 modulates the received optical signal E11 to the different modulated wavelengths as previously discussed.

In other words, based on the control signal 491-11, the modulator M1-1 modulates the wavelength W1 associated with the optical signal E11 to produce the optical signal B11 as per the data transmission requirements of the processor or load 118. Based on the control signal 491-12, the modulator M1-2 modulates the wavelength W2 associated with the optical signal E11 to produce the optical signal B12. Based on the control signal 491-13, the modulator M1-3 modulates the wavelength W3 associated with the optical signal E11 to produce the optical signal B13. Based on the control signal 491-14, the modulator M1-4 modulates the wavelength W4 associated with the optical signal E11 to produce the optical signal B14.

As its name suggest, the optical combiner 461-12 combines the modulated wavelengths W1, W2, W3, W4 (optical signals B11, B12, B13, and B14) for transmission over the optical fiber 161-11 as one or more signal S11.

Note that the optical fiber 161-11 may be any suitable length and can consist of multiple fiber cores. It is also noted that the multiplexer 461-12 can be part of the optical fiber such that each wavelength is focused into an individual fiber and thus further simplifying the assembly.

As further shown, the optical fiber 161-11 conveys the one or more signals S11 (optical signals B11, B12, B13, and B14) to the target communication device 499 that further processes the received one or more signals S11 to retrieve respective data provided by the load 118 and included in the modulated wavelengths in the optical signal S11.

Accordingly, the optical component assembly 151 (such as an apparatus) can be configured to include: i) a substrate 153, ii) modulator assembly such as one or more of the optical modulator M1, optical modulator M2, etc., iii) an optical transmitter device such as transmitter T11 affixed to the substrate 153, the optical transmitter device T11 can be configured to transmit an optical signal E11, and iv) a wavelength filter device such as modulator assembly or optical modulator M1 to receive the optical signal E11 (including wavelengths of light W1, W2, W3, and W4) to control conveyance of the different wavelengths (including wavelengths of light W1, W2, W3, and W4) of the optical signal E11 to the WDM transmitters 461-11, where each of the modulator elements (optical modulators M1-1, M1-2, M1-3, and M1-4) is operative to control a respective received wavelength of the different wavelengths of the optical signal E11 to an optical fiber 161-11 for transmission over the optical fiber 161-11 to a remote destination such as the communication device 499.

As previously discussed, the optical transmitter device 151-11 can be configured to include a respective optical lens 451-11 disposed between the optical device (transmitter T11) and the wavelength filter device (a.k.a., modulator assembly M1).

Further, as previously discussed, the electrically conductive paths 491 extending through the substrate 153 to the modulator elements (such as the optical modulator M1-1, optical modulator M1-2, optical modulator M1-3, and optical modulator M1-4) in the modulator assembly M1 can be configured to convey modulator control signals (a.k.a., signals 491-1 including control signal 491-11, control signal 491-12, control signal 491-13, control signal 491-14) to the modulator elements (M1-1, M1-2, M1-3, and M1-4) of the modulator assembly M1.

Thus, the modulator control signals (491-1) conveyed over the electrically conductive paths 491 can be configured to include a first modulator control signal 491-11 conveyed from the substrate 153 to a first modulator element (optical modulator M1-1) of the modulator assembly M1, the first modulator element M1 modulates the first wavelength W1 (optical signal B11) of the multiple different wavelengths in accordance with the first modulator control signal 491-11 supplied to the optical modulator M1-1. In one example, depending on the control signal 491-11, the optical modulator M1-1 either blocks or allows passage of the wavelength W1 associated with the respective continuous optical signal E11 (optical signal B11) and state of the control signal 491-11. One state (ON-state) of the control signal 491-11 applied to the modulator M1-1 allows passage of the received wavelength W1 associated with the signal E11 through the modulator M1-1 to the combiner 461-11, a second state (OFF-state) of the control signal 491-11 blocks passage of the received wavelength W1 associated with the signal E11 through the modulator M1-1 to the combiner 461-11 and corresponding optical fiber 161-11.

The modulator control signals (491-2) conveyed over the electrically conductive paths 491 can be configured to include a modulator control signal 491-12 conveyed from the substrate 153 to a second modulator element (optical modulator M1-2) of the modulator assembly M1, the second modulator element M2 modulates the first wavelength W2 (optical signal B12) of the multiple different wavelengths in accordance with the second modulator control signal 491-12 supplied to the optical modulator M1-2. In one example, depending on the control signal 491-12, the optical modulator M1-2 either blocks or allows passage of the wavelength W2 associated with the respective continuous optical signal E11 and state of the control signal 491-12. One state (ON-state) of the control signal 491-12 applied to the modulator M1-2 allows passage of the received wavelength W2 associated with the signal E11 through the modulator M1-2 to the combiner 461-11, a second state (OFF-state) of the control signal 491-12 blocks passage of the received wavelength W1 associated with the signal E11 through the modulator M1-1 to the combiner 461-11. In all these examples, the ON-State of the modulator represents a digital 1 while the Off-State of the control signal corresponds to the digital 0 state of the data.

It is further noted that some communication systems use multiple levels for transmitting more than one bit per channel. One such example is PAM4 (Pulse Amplitude Modulation with 4 levels). PAM4 is a signaling method that uses four voltage levels to encode data, which can be electrical or optical. In this scenario, the modulators M1-1 to 4 and/or M2-1 to 4 can be configured to provide four different light levels as encoded by the control signal 491.

In a similar manner, in accordance with the control signal 491-13 conveyed over the electrically conductive paths 491 to the modulator M1-3, the modulator M1-3 controls conveyance of the wavelength W3 associated with the optical signal E11 to the combiner 461-11 for transmission over the optical fiber 161-11. In one example, when the control signal 491-13 is a logic low, the modulator M1-3 blocks the wavelength W3 from passing to the optical fiber 161-11; when the control signal 491-13 is a logic high, the modulator M1-3 passes the wavelength W3 to the optical fiber 161-11.

In accordance with the control signal 491-14 conveyed over the electrically conductive paths 491 to the modulator M1-4, the modulator M1-4 controls conveyance of the wavelength W4 associated with the optical signal E11 to the combiner 461-11 for transmission over the optical fiber 161-11. In one example, when the control signal 491-14 is a logic low, the modulator M1-4 blocks the wavelength W4 from passing to the optical fiber 161-11; when the control signal 491-14 is a logic high, the modulator M1-4 passes the wavelength W4 to the optical fiber 161-11.

Additionally, the optical component assembly 151 (such as an apparatus) can be configured to include: an optical transmitter device such as transmitter T12 affixed to the substrate 153, the optical transmitter device T12 can be configured to transmit an optical signal E12, and iv) a wavelength filter device such as modulator assembly or optical modulator M2 to receive the optical signal E12 (including wavelengths of light W1, W2, W3, and W4) and to control conveyance of the different wavelengths (including wavelengths of light W1, W2, W3, and W4) of the optical signal E12 (such as optical signals B21, B22, B23, and B24) to the WDM transmitters 462-11, where each of the modulator elements (optical modulators M2-1, M2-2, M2-3, and M2-4) is operative to control a respective received wavelength of the different wavelengths of the optical signal E12 to an optical fiber 161-12 for transmission (such as optical signals B21, B22, B23, and B24, which are modulation of each of the wavelengths W1 through W4) over the optical fiber 161-12 to a remote destination such as the communication device 499.

As previously discussed, if desired, the optical transmitter device 151-12 can be configured to include a respective optical lens 451-12 disposed between the optical device (transmitter T12) and the wavelength filter device (a.k.a., modulator assembly M2). The lens 451-12 can be configured to direct the different wavelengths W1-W4 of the optical signal E12 to the different modulators in the modulator assembly M2 as shown.

Further, as previously discussed, the electrically conductive paths 492 extending through the substrate 153 to the modulator elements (such as the optical modulator M2-1, optical modulator M2-2, optical modulator M2-3, and optical modulator M2-4) in the modulator assembly M2 can be configured to convey modulator control signals (a.k.a., signals 492-1 including control signal 492-11, control signal 492-12, control signal 492-13, control signal 492-14) to the respective modulator elements (M2-1, M2-2, M2-3, and M2-4) of the modulator assembly M2.

Thus, the modulator control signals (492-1) conveyed over the electrically conductive paths 492 can be configured to include a first modulator control signal 492-11 conveyed from the substrate 153 to a first modulator element (optical modulator M2-1) of the modulator assembly M2, where the first modulator element M2-1 modulates the first wavelength W1 of the multiple different wavelengths of optical signal E12 in accordance with the first modulator control signal 492-11 supplied to the optical modulator M2-1. In one example, depending on the control signal 492-11, the optical modulator M2-1 either blocks or allows passage of the wavelength W1 associated with the respective continuous optical signal E12 and state of the control signal 492-11. One state (ON-state such as a logic high) of the control signal 492-11 applied to the modulator M2-1 allows passage of the received wavelength W1 associated with the signal E12 (a.k.a., optical signal B21) through the modulator M2-1 to the combiner 462-11; a second state (OFF-state such as a logic low) of the control signal 492-11 blocks passage of the received wavelength W1 associated with the signal E12 through the modulator M2-1 to the combiner 462-11 and corresponding optical fiber 162-11.

In a similar manner, in accordance with the control signal 492-12 conveyed over the electrically conductive paths 492 to the modulator M2-2, the modulator assembly controls conveyance of the wavelength W2 associated with the optical signal E12 to the combiner 462-11 for transmission over the optical fiber 162-11. In one example, when the control signal 492-12 is a logic low, the modulator M2-2 blocks the wavelength W2 of the optical signal E12 (a.k.a., optical signal B22) from passing to the optical fiber 161-12; when the control signal 491-12 is a logic high, the modulator M2-2 passes the wavelength W2 of optical signal E12 to the optical fiber 161-12.

In a similar manner, in accordance with the control signal 492-13 conveyed over the electrically conductive paths 492 to the modulator M2-3, the modulator M2-3 controls conveyance of the wavelength W3 associated with the optical signal E12 (a.k.a., optical signal B23) to the combiner 462-11 for transmission over the optical fiber 161-12. In one example, when the control signal 492-13 is a logic low, the modulator M2-3 blocks the wavelength W3 of the optical signal E12 from passing to the optical fiber 161-12; when the control signal 492-13 is a logic high, the modulator M2-3 passes the wavelength W3 of the optical signal E12 to the optical fiber 161-12.

In accordance with the control signal 492-14 conveyed over the electrically conductive paths 492 to the modulator M2-4, the modulator M2-4 controls conveyance of the wavelength W4 associated with the optical signal E12 (a.k.a., optical signal B24) to the combiner 462-11 for transmission over the optical fiber 161-12. In one example, when the control signal 492-14 is a logic low, the modulator M2-4 blocks the wavelength W4 of the optical signal E12 from passing to the optical fiber 161-12; when the control signal 492-14 is a logic high, the modulator M2-4 passes the wavelength W4 of the optical signal E12 to the optical fiber 161-12.

As further shown, the communication device 499 or other suitable entity includes optical demultiplexer 461-13 to steer the different wavelengths of signal S11 (optical signals B21, B22, B23, B24), to a respective one of the multiple WDM receivers 461-14. The WDM receivers 461-14 convert the optical signals into electrical signals including the data transmitted by the load 118 to reproduce the original optical signals B21, B22, B23, B24. The communication device 499 or other suitable entity includes optical demultiplexers 462-13 to steer the different wavelengths of signal S12 to a respective one of the multiple WDM receivers 462-14. The WDM receivers 462-14 convert the optical signals into electrical signals including the data transmitted by the load 118.

FIG. 5 is an example side view diagram illustrating implementation of an optical system including an optical component assembly to receive data as discussed herein.

In this example, the optical component assembly 151 and corresponding optical receiver device 151-21 includes optical receiver device R11, optical receiver device R12, optical receiver device R13, and optical receiver device R14 supporting reception of data over the optical fiber 161-21.

More specifically, the communication device 499 transmits respective first data over optical signal D11 at wavelength W1; the communication device 499 transmits the second data over optical signal D12 at wavelength W2; the communication device 499 transmits third data over optical signal D13 at wavelength W3; the communication device 499 transmits fourth data over optical signal D14 at wavelength W4.

As further shown, the optical receiver device 151-21 of the optical component assembly 151 includes one or more of: optical demultiplexer 561-13, DWM receivers 561-14, one or more lenses 551-11, optical receiver device R11 disposed in or on the substrate 153, optical receiver device R12 disposed in or on the substrate 153, optical receiver device R13 disposed in or on the substrate 153, and optical receiver device R14 disposed in or on the substrate 153.

The WDM transmitters 561-11 receive and forward the respective optical signals received from the communication device 499 to the optical combiner 561-12. The optical combiner 561-12 transmits a combination of the received optical signals D11, D12, D13, and D14 over the optical fiber 161-21.

The optical demultiplexer 561-13 at the end of the optical fiber 161-21 receives the optical signals D11, D12, D13, and D14 and splits up the optical signals received over the optical fiber 161-21 into: optical signal D11 supplied to the optical receiver device R11 disposed on or in the optical component assembly 151, optical signal D12 supplied to the optical receiver device R12 disposed on or in the optical component assembly 151, optical signal D13 supplied to the optical receiver device R13 disposed on or in the optical component assembly 151, optical signal D14 supplied to the optical receiver device R14 disposed on or in the optical component assembly 151.

As further shown, the optical receiver device R11 (such as a planar device disposed in the x-z plane) converts the received optical signal D11 (transmitted substantially parallel to the y-axis) into the electrical signal X11, which is transmitted over the electrically conductive path P11 for delivery through the assembly 101 to the load 118. The electrically conductive path P11 may extend from the optical component assembly 151 through the redistribution layer 141 and the circuit assembly 131 and back through the redistribution layer 141 to the load 118. Alternatively, the electrically conductive path P11 may extend from the optical component assembly 151 through the redistribution layer 141 to the load 118 without passing through the circuit assembly 131.

The optical receiver device R12 (such as a planar device disposed in the x-z plane) converts the received optical signal D12 (transmitted substantially parallel to the y-axis) into the electrical signal X12 transmitted over the electrically conductive path P12 for delivery to the load 118. The electrically conductive path P12 may extend from the optical component assembly 151 through the redistribution layer 141 and the circuit assembly 131 and back through the redistribution layer 141 to the load 118. Alternatively, the electrically conductive path P12 may extend from the optical component assembly 151 through the redistribution layer 141 to the load 118 without passing through the circuit assembly 131.

The optical receiver device R13 (such as planar device disposed in the x-z plane) converts the received optical signal D13 (transmitted substantially parallel to the y-axis) into the electrical signal X13, which is transmitted over the electrically conductive path P13 for delivery to the load 118. The electrically conductive path P13 may extend from the optical component assembly 151 through the redistribution layer 141 and the circuit assembly 131 and back through the redistribution layer 141 to the load 118. Alternatively, the electrically conductive path P13 may extend from the optical component assembly 151 through the redistribution layer 141 to the load 118 without passing through the circuit assembly 131.

The optical receiver device R14 (such as disposed in the x-z plane) converts the received optical signal D14 (transmitted substantially parallel to the y-axis) into the electrical signal X14 transmitted over the electrically conductive path P14 for delivery to the load 118. The electrically conductive path P14 may extend from the optical component assembly 151 through the redistribution layer 141 and the circuit assembly 131 and back through the redistribution layer 141 to the load 118. Alternatively, the electrically conductive path P14 may extend from the optical component assembly 151 through the redistribution layer 141 to the load 118 without passing through the circuit assembly 131.

Further in this example, the optical component assembly 151 and corresponding optical receiver device 151-22 includes: optical receiver device R21, optical receiver device R22, optical receiver device R23, and optical receiver device R24 supporting reception of data and corresponding signals D21, D22, D23, and D24 transmitted over the optical fiber 161-22.

More specifically, the communication device 499 transmits respective first data over optical signal D21 at wavelength W1; the communication device 499 transmits the second data over optical signal D22 at wavelength W2; the communication device 499 transmits third data over optical signal D23 at wavelength W3; the communication device 499 transmits fourth data over optical signal D24 at wavelength W4.

As further shown, the optical receiver device 151-22 of the optical component assembly 151 includes one or more of: optical demultiplexer 562-13, DWM receivers 562-14, one or more lenses 551-12, optical receiver device R21 disposed in or on the substrate 153, optical receiver device R22 disposed in or on the substrate 153, optical receiver device R23 disposed in or on the substrate 153, and optical receiver device R24 disposed in or on the substrate 153.

The WDM transmitters 562-11 receive and forward the respective optical signals received from the communication device 499 to the optical combiner 562-12. The optical combiner 562-12 transmits a combination of the received optical signals D21, D22, D23, and D24 over the optical fiber 162-22.

The optical demultiplexer 562-13 at the end of the optical fiber 161-22 receives the optical signals D21, D22, D23, and D24 and splits up the optical signals received over the optical fiber 161-22 into: optical signal D21 supplied to the optical receiver device R21 disposed on or in the optical component assembly 151, optical signal D22 supplied to the optical receiver device R22 disposed on or in the optical component assembly 151, optical signal D23 supplied to the optical receiver device R23 disposed on or in the optical component assembly 151, optical signal D24 supplied to the optical receiver device R24 disposed on or in the optical component assembly 151.

As further shown, the optical receiver device R21 (such as planar device disposed in the x-z plane) converts the received optical signal D21 (transmitted substantially parallel to the y-axis) into the electrical signal X21 transmitted over the electric the conductive path P21 for delivery to the load 118. The electrically conductive path P21 may extend from the optical component assembly 151 through the redistribution layer 141 and the circuit assembly 131 and back through the redistribution layer 141 to the load 118. Alternatively, the electrically conductive path P21 may extend from the optical component assembly 151 through the redistribution layer 141 to the load 118 without passing through the circuit assembly 131.

The optical receiver device R22 (such as planar device disposed in the x-z plane) converts the received optical signal D22 (transmitted substantially parallel to the y-axis) into the electrical signal X22 transmitted over the electrically conductive path P22 for delivery to the load 118. The electrically conductive path P22 may extend from the optical component assembly 151 through the redistribution layer 141 and the circuit assembly 131 and back through the redistribution layer 141 to the load 118. Alternatively, the electrically conductive path P22 may extend from the optical component assembly 151 through the redistribution layer 141 to the load 118 without passing through the circuit assembly 131.

The optical receiver device R23 (such as planar device disposed in the x-z plane) converts the received optical signal D23 (transmitted substantially parallel to the y-axis) into the electrical signal X23 transmitted over the electrically conductive path P23 for delivery to the load 118. The electrically conductive path P23 may extend from the optical component assembly 151 through the redistribution layer 141 and the circuit assembly 131 and back through the redistribution layer 141 to the load 118. Alternatively, the electrically conductive path P23 may extend from the optical component assembly 151 through the redistribution layer 141 to the load 118 without passing through the circuit assembly 131.

The optical receiver device R24 (such as planar device disposed in the x-z plane) converts the received optical signal D24 (transmitted substantially parallel to the y-axis) into the electrical signal X24 transmitted over the electrically conductive path P24 for delivery to the load 118. The electrically conductive path P24 may extend from the optical component assembly 151 through the redistribution layer 141 and the circuit assembly 131 and back through the redistribution layer 141 to the load 118. Alternatively, the electrically conductive path P24 may extend from the optical component assembly 151 through the redistribution layer 141 to the load 118 without passing through the circuit assembly 131.

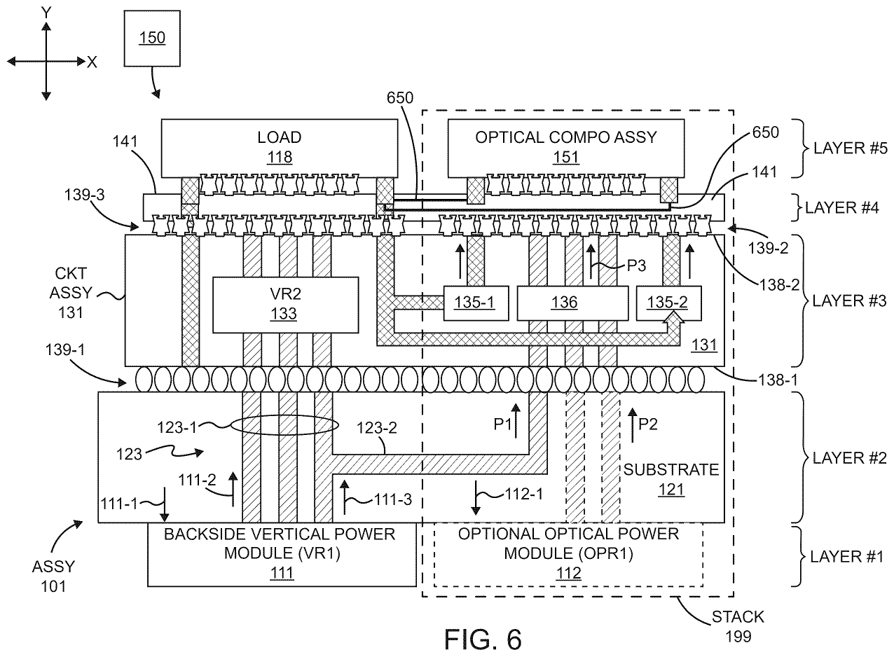

Just as explained for the transmission device of FIG. 4, the ON-State of the data may be represented by high current or voltage state of the receiver while the Off-State of the data, can be represented by low current or voltage level of the receiver. It is further noted that in some communication systems uses multiple levels for transmitting more than one bit per channel. One such example is PAM4 (Pulse Amplitude Modulation with 4 levels). PAM4 is a signaling method that uses four voltage levels to encode data, which can be electrical or optical. In this scenario, the receiver R1-1 to 4 and/or R2-1 to 4 can be configured to provide four different electrical current or voltage levels as encoded by the control signal 491 by the communication device 499. FIG. 6 is an example diagram illustrating fabrication of an apparatus including a stack of multiple circuit layers supporting transmission and reception of data as discussed herein.

This example illustrates that any of the electrically conductive paths between the load 118 and the corresponding optical component assembly 151 may pass through the redistribution layer 141 (substrate including one or more layers of electrically conductive paths). In such an instance, the redistribution layer 141 disposed between the second surface 138-2 of the first circuit assembly 131 and the optical component assembly 151. The redistribution layer 141 can be configured to include electrically conductive paths 650 operative to convey any of the signals as discussed herein between the multiple optical devices of the optical component assembly 151 and a load 118 such as a data processor affixed to the redistribution layer 141.

As previously discussed, the optical component assembly 151 can be configured to include multiple optical devices such as optical transmitter devices and optical receiver devices. Each respective optical transmitter device of the optical transmitter devices may be operative to convert a respective electrical signal received from the data processor into a respective optical signal transmitted from the respective optical transmitter device. Each respective optical receiver device of the optical receiver devices may be operative to convert a respective optical signal received by the respective optical receiver device into a respective electrical signal transmitted to the data processor.

FIG. 7 is an example illustrating fabrication and implementation of an apparatus including a circuit assembly disposed in a stack of circuit layers as discussed herein.

As previously discussed, the assembly 101 can be implemented without the redistribution layer 141. In such an instance, the assembly 101-1 includes 4 stacked layers of circuit components (such as one or more substrates, one or more circuit packages, one or more circuit component, etc.)

Note again that techniques herein are well suited for use in circuit assembly applications such as those providing power delivery to one or more optical assemblies. However, it should be noted that the disclosure of matter herein is not limited to use in such applications and that the techniques discussed herein are well suited for other applications as well.

While this invention has been particularly shown and described with references to preferred aspects thereof, it will be understood by those skilled in the art that various changes in form and details may be made therein without departing from the spirit and scope of the present application as defined by the appended claims. Such variations are intended to be covered by the scope of this present application. As such, the foregoing description in the present disclosure is not intended to be limiting. Rather, any limitations to the invention are presented in the following claims.

1. An apparatus comprising:
a first circuit assembly including:
a first surface and a second surface;
a first interface operative to couple the first surface of the first circuit assembly to a first substrate; and
a second interface operative to support first connectivity from the second surface of the first circuit assembly to an optical component assembly, the optical component assembly including multiple optical devices controlled via driver circuitry disposed in the first circuit assembly between the first surface and the second surface.

2. The apparatus as in claim 1, wherein the multiple optical devices of the optical component assembly are configured to receive and transmit optical signals propagating substantially orthogonal with respect to the second surface of the first circuit assembly.

3. The apparatus as in claim 2, wherein the first circuit assembly further includes:
a third interface disposed on the second surface, the third interface operative to provide second connectivity of the first circuit assembly to a load; and
electrically conductive paths supporting third connectivity between the load and the driver circuitry disposed in the first circuit assembly.

4. The apparatus as in claim 3, wherein the optical component assembly includes a third substrate; and
wherein the multiple optical devices are disposed on a surface of the third substrate, the surface of the third substrate disposed parallel to the second surface of the first substrate.

5. The apparatus as in claim 1 further comprising:
a processor component coupled to the second surface of the first circuit assembly, the processor component disposed adjacent to the optical component assembly; and
electrically conductive paths disposed in the first circuit assembly between the driver circuitry and the processor component.

6. The apparatus as in claim 1 further comprising:
a redistribution layer disposed between the second surface of the first circuit assembly and the optical component assembly, the redistribution layer including electrically conductive paths operative to convey signals between the multiple optical devices of the optical component assembly and a data processor affixed to the redistribution layer.

7. The apparatus as in claim 6, wherein the multiple optical devices include optical transmitter devices and optical receiver devices;
wherein each respective optical transmitter device of the optical transmitter devices is operative to convert a respective electrical signal received from the data processor into a respective optical signal transmitted from the respective optical transmitter device; and
wherein each respective optical receiver device of the optical receiver devices is operative to convert a respective optical signal received by the respective optical receiver device into a respective electrical signal transmitted to the data processor.

8. The apparatus as in claim 1, wherein the first substrate is a motherboard substrate operative to supply power to the first circuit assembly for redistribution to an optical component assembly; and
wherein the backside vertical power module is used to provide power to the load or a processor as well as the optical component assembly through a motherboard and package substrate.

9. The apparatus as in claim 1 further comprising:
an electronic component coupled to the second surface of the first circuit assembly, the electronic component being disposed adjacent to the optical component assembly;
first electrically conductive paths extending through the first circuit assembly between the electronic component and optical transmitter devices disposed in the optical component assembly, the first electrically conductive paths operative to convey first electrical signals from the electronic component to the optical transmitter devices; and
second electrically conductive paths extending through the first circuit assembly between optical receiver devices of the optical component assembly and the electronic component, the second electrically conductive paths operative to convey second electrical signals from the optical receiver devices to the electronic component.

10. The apparatus as in claim 1, wherein the multiple optical devices of the optical component assembly are coupled to a surface of the optical component assembly, the multiple optical devices configured to receive/transmit optical signals which travel in a direction substantially orthogonal with respect to the surface of the optical component assembly.

11. The apparatus as in claim 1, wherein the optical component assembly includes: i) a third substrate coupled to the second interface of the first circuit assembly, and ii) where the multiple optical devices are affixed to a first surface of the third substrate, the first surface of the third substrate disposed parallel to the second surface of the first circuit assembly.

12. A component stack comprising:
a first layer including the optical component assembly of claim 1;
a second layer including the first circuit assembly as in claim 1, the first circuit assembly comprising: i) a power converter disposed between the first surface of the first circuit assembly and the second surface of the first circuit assembly, the power converter operative to convert a received input voltage into an output voltage, and ii) electrically conductive paths operative to convey the output voltage from the power converter to the multiple optical devices of the optical component assembly;
a third layer including the first substrate; and
wherein the second layer is disposed between the first layer and the second layer.

13. The apparatus as in claim 1, wherein the second interface includes a third substrate disposed between the first circuit assembly and the optical component assembly, the third substrate providing electrical connectivity between the first circuit assembly and the optical component assembly.

14. An apparatus comprising:
a substrate;
a modulator assembly; and
an optical transmitter device affixed to the substrate, the optical transmitter device configured to transmit an optical signal transmitted in a direction orthogonal to the surface of the substrate, the optical signal including different wavelengths transmitted to optical modulator elements in the modulator assembly, each of the optical modulator elements operative to control modulation of a respective received wavelength of the different wavelengths of the optical signal onto an optical fiber for transmission over the optical fiber to a remote destination.

15. The apparatus as in claim 14 further comprising:
an optical lens disposed between the optical transmitter device and the optical modulator elements in the modulator assembly.

16. The apparatus as in claim 14 further comprising:
electrically conductive paths extending through the substrate to the optical modulator elements in the modulator assembly, the electrically conductive paths operative to convey modulator control signals to the optical modulator elements of the modulator assembly.

17. The apparatus as in claim 16, wherein the modulator control signals include a first modulator control signal conveyed from the substrate to a first optical modulator element of the modulator assembly, the first optical modulator element operative to modulate a first wavelength of the multiple different wavelengths in accordance with the first modulator control signal; and
wherein the modulator control signals include a second modulator control signal conveyed from the substrate to a second optical modulator element of the modulator assembly, the second optical modulator element operative to modulate a second wavelength of the multiple different wavelengths in accordance with the second modulator control signal.

18. An apparatus comprising:
a substrate;
an optical interface to receive an optical signal;
an optical splitter disposed between the optical interface and the substrate, the optical splitter operative to split the received optical signal into different wavelengths; and
multiple optical receiver devices affixed to a surface of the substrate, the multiple optical receiver devices operative to receive the different wavelengths of the optical signal, the different wavelengths of the optical signal received by the multiple optical receiver devices in a direction orthogonal to the surface of the substrate.

19. The apparatus as in claim 18, wherein the optical splitter includes a wavelength demultiplexer operative to split the received optical signal into the different wavelengths of the optical signal.

20. The apparatus as in claim 19, wherein the multiple optical receiver devices include a first optical receiver device affixed to the substrate, the first optical receiver device operative to receive a first wavelength of the optical signal and convert the received first wavelength of the optical signal into a first electrical signal;
wherein the multiple optical receiver devices include a second optical receiver device affixed to the substrate, the second optical receiver device operative to receive a second wavelength of the optical signal and convert the received second wavelength of the optical signal into a second electrical signal, the apparatus further comprising:
a first electrically conductive path extending from the first optical receiver device through the substrate, the first electrically conductive path operative to convey the first electrical signal; and
a second electrically conductive path extending from the second optical receiver device through the substrate, the first electrically conductive path operative to convey the first electrical signal.
